(19) United States
(12) Patent Application Publication
(10) Pub. No.: US 2007/0236636 A1
(43) Pub. Date: Oct. 11, 2007

(54) Contrast ratio enhancement optical stack

(76) Inventors: Philip E. Watson, St. Paul, MN (US); Richard C. Allen, Lilydale, MN (US)

Correspondence Address: 3M INNOVATIVE PROPERTIES COMPANY, PO BOX 33427, ST. PAUL, MN, 55133-3427, US

(21) Appl. No.: 11/394,480

(22) Filed: Mar. 31, 2006

(51) Int. Cl. G02F 1/1335

(52) U.S. Cl. 349/117

(57) ABSTRACT

An optical film stack is disclosed that includes a linear absorbing polarizer layer having a first polarizing transmission axis, a linear reflecting polarizer layer having a second polarizing transmission axis substantially parallel to the first polarizing transmission axis, and a retarder layer having an out-of-plane retardance value of 80 nanometers or more, or having an in-plane retardance value of 10 nanometers or greater and an out-of-plane retardance value greater than (0.6 times the in-plane retardance value). The retarder layer is disposed between the linear absorbing polarizer layer and the linear reflecting polarizer layer. A liquid crystal display including this optical film stack and methods of increasing on-axis contrast ratio of a liquid crystal display utilizing this optical film stack are also disclosed.

### BACKGROUND

The present disclosure relates generally to optical stacks for displays, and particularly to optical stacks that improve contrast ratio of liquid crystal displays.

Microprocessor-based devices that include electronic displays for conveying information to a viewer have become nearly ubiquitous. Mobile phones, handheld computers, personal digital assistants, electronic games, car stereos and indicators, public displays, automated teller machines, in-store kiosks, home appliances, computer monitors, televisions and others are all examples of devices that include information displays viewed on a daily basis. Many of the displays provided on such devices are liquid crystal displays (“LCDs”).

Unlike cathode ray tube (CRT) displays, LCDs do not emit light and, thus, require a separate light source for viewing images formed on such displays. For example, a source of light can be located behind the display, which is generally known as a “backlight.” Some traditional backlights include one or more brightness enhancing films having linear prismatic surface structures, such as Vikuiti™ Brightness Enhancement Film (BEF), available from 3M Company. One or more reflective polarizer films are also typically included into a backlight, such as Vikuiti™ Dual Brightness Enhancement Film (DBEF) or Vikuiti™ Diffuse Reflective Polarizer Film (DRPF), both available from 3M Company. DBEF and/or DRPF transmit light with a predetermined polarization. Light with a different polarization is reflected back into the backlight, where the polarization state of that light is usually scrambled, e.g., with diffusers and other “random” polarization converting elements, and the light is fed back into the reflective polarizer. This process is usually referred to as “polarization recycling.”

Liquid crystal displays, such as for example, twisted nematic (TN), single domain vertically aligned (VA), optically compensated birefringent (OCB) liquid crystal displays and the like, have inherently narrow and non-uniform viewing angle characteristics. Such viewing angle characteristics can describe, at least in part, the optical performance of a display. Characteristics such as contrast, color, and gray scale intensity profile can vary substantially in uncompensated displays for different viewing angles. There is a desire to modify these characteristics from those of an uncompensated display to provide a desired set of characteristics as a viewer changes positions horizontally, vertically, or both and for viewers at different horizontal and vertical positions.

The range of viewing angles that are important can depend on the application of the liquid crystal display. For example, in some applications, a broad range of horizontal positions may be desired, but a relatively narrow range of vertical positions may be sufficient. In other applications, viewing from a narrow range of horizontal or vertical angles (or both) may be desirable. Accordingly, the desired optical compensation for non-uniform viewing angle characteristics can depend on the desired range of viewing positions. One viewing angle characteristic is the contrast ratio between the bright state and the dark state of the liquid crystal display. The contrast ratio can be affected by a variety of factors.

### SUMMARY

In one exemplary implementation, the present disclosure is directed to an optical film stack is disclosed that includes a linear absorbing polarizer layer having a first polarizing transmission axis, a linear reflecting polarizer layer having a second polarizing transmission axis substantially parallel to the first polarizing transmission axis, and a retarder layer having an out-of-plane retardance value of 80 nanometers or more, or having an in-plane retardance value of 10 nanometers or greater and an out-of-plane retardance value greater than (0.6 times the in-plane retardance value). The retarder layer is disposed between the linear absorbing polarizer layer and the linear reflecting polarizer layer.

In another exemplary implementation, the present disclosure is directed to a liquid crystal display including a liquid crystal layer, a light source, and an optical film stack disposed between the first liquid crystal layer and the light source. The optical film stack includes a linear absorbing polarizer layer having a first polarizing transmission axis being disposed facing the liquid crystal layer, a linear reflecting polarizer layer having a second polarizing transmission axis that is substantially parallel to the first polarizing transmission axis being disposed to receive light from the light source, and a retarder layer having an out-of-plane retardance value of 80 nanometers or more, or having an in-plane retardance value of 10 nanometers or greater and an out-of-plane retardance value greater than (0.6 times the in-plane retardance value). The retarder layer is disposed between the linear absorbing polarizer layer and the linear reflecting polarizer layer.

In a further exemplary implementation, a method of increasing an on-axis contrast ratio of a liquid crystal display is described. The method includes providing a liquid crystal display that includes a liquid crystal layer, a light source, and an optical stack disposed between the liquid crystal layer and the light source. The optical stack includes a linear absorbing polarizer layer having a first polarizing transmission axis being disposed facing the liquid crystal layer, and a linear reflecting polarizer layer having a second polarizing transmission axis substantially parallel to the first polarizing transmission axis being disposed to receive light from the light source. This liquid crystal display has a first on-axis contrast ratio. A retarder layer is then disposed between the linear absorbing polarizer layer and the linear reflecting polarizer layer to form an improved liquid crystal display having a second on-axis contrast ratio that is greater than the first on axis contrast ratio. The retarder layer has an out-of-plane retardance value of 80 nanometers or more, or having an in-plane retardance value of 10 nanometers or greater and an out-of-plane retardance value greater than (0.6 times the in-plane retardance value).

These and other aspects of the optical film stacks and liquid crystal display devices according to the subject invention will become readily apparent to those of ordinary skill in the art from the following detailed description together with the drawings.

### BRIEF DESCRIPTION OF THE DRAWINGS

So that those having ordinary skill in the art to which the subject invention pertains will more readily understand how to make and use the subject invention, exemplary embodiments thereof will be described in detail below with reference to the drawings, in which:

FIG. 1 illustrates an axis system for use in describing the optical elements of the present disclosure; and

FIG. 2 is a schematic cross-sectional view of an exemplary display device and an exemplary optical film stack constructed according to the present disclosure.

### DETAILED DESCRIPTION

Performance of a display device, such as an LCD, is often judged by its brightness. Use of a larger number of light sources and/or of brighter light sources is one way of increasing brightness of a display. However, additional light sources and/or brighter light sources consume more energy, which typically requires allocating more power to the display device. For portable devices this may correlate to decreased battery life. Adding light sources to the display device or using brighter light sources may increase the cost and weight of the display device.

Another way of increasing brightness of a display device involves more efficiently utilizing the light that is available within the display device or within its lighting device such as a backlight. For example, light within a display device or a lighting device may be “polarization recycled” using a reflective polarizer, such that the reflective polarizer transmits at least a substantial amount of light having a desired polarization characteristic and reflects at least a substantial amount of light having a different polarization characteristic. The polarization of the reflected (i.e., rejected) light then may be altered by other elements in the lighting device and fed back to the reflective polarizer, whereupon the recycling sequence repeats.

Although the polarization recycling mechanism described above is very effective in providing a brighter display with the same power allocation, at least some light is usually lost with each repeating recycling sequence. For example, obliquely directed light tends to scatter from structures within the display panel and from particles in the color filter and some of this scattered light ends up in the normal (axial) direction, resulting in light leakage in the dark state of the display.

Accordingly, the present disclosure is directed to optical film stacks for displays, and particularly to optical film stacks that improve on-axis contrast ratio of liquid crystal displays by reducing oblique illumination. While the present invention is not so limited, an appreciation of various aspects of the invention will be gained through a discussion of the examples provided below.

The following description should be read with reference to the drawings, in which like elements in different drawings are numbered in like fashion. The drawings, which are not necessarily to scale, depict selected illustrative embodiments and are not intended to limit the scope of the disclosure. Although examples of construction, dimensions, and materials are illustrated for the various elements, those skilled in the art will recognize that many of the examples provided have suitable alternatives that may be utilized.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, an and “the” encompass embodiments having plural referents, unless the content clearly dictates otherwise. For example, reference to “a film” encompasses embodiments having one, two or more films. As used in this specification and the appended claims, the term “or” is generally employed in its sense including “and/or” unless the content clearly dictates otherwise.

The term “polarization” refers to plane or linear polarization, circular polarization, elliptical polarization, or any other nonrandom polarization state in which the electric vector of the beam of light does not change direction randomly, but either maintains a constant orientation or varies in a systematic manner. With in-plane polarization, the electric vector remains in a single plane, while in circular or elliptical polarization, the electric vector of the beam of light rotates in a systematic manner.

The term “birefringent” means that the indices of refraction in orthogonal x, y, and z directions are not all the same. For the polymer layers described herein, the axes are selected so that x and y axes are in the plane of the layer and the z axis corresponds to the thickness or height of the layer. The term “in-plane birefringence” is understood to be the difference between the in-plane indices (nₓ and n_{y}) of refraction. The term “out-of-plane birefringence” is understood to be the difference between one of the in-plane indices (nₓ or n_{y}) of refraction and the out-of-plane index of refraction n_{z}.

The retardance of a birefringent film is the phase difference introduced when light passes through a medium of a thickness (d), based on the difference in the speeds of advance of light polarized along the slow axis, which is the axis orthogonal to the light propagation direction and characterized by a larger value of the refractive index, and along the axis or direction normal thereto. In some exemplary embodiments utilizing oriented polymeric films at normal and nearly normal incidence of light, the slow axis is collinear with the direction in which the film is stretched, and thickness d becomes the thickness of the film. The retardance or retardation is represented by the product Δn·d, where Δn is the difference in refractive indexes along the slow axis and the direction normal thereto, and d is the medium thickness traversed by the light.

The term “in-plane retardation” refers to the product of the difference between two orthogonal in-plane indices of refraction times the thickness of the optical element. The value of in-plane retardation can be either a positive value or a negative value, however, it is always reported here as an absolute value.

The term “out-of-plane retardation” refers to the thickness of the optical element times the difference between n_{z} and nₓ or between n_{z} and the average of nₓ and n_{y}. The value of out-of-plane retardation can be either a positive value or a negative value, however, it is always reported here as an absolute value.

A “biaxial retarder” denotes a birefringent optical element, such as, for example, a plate or film, having different indices of refraction along all three axes (i.e., nₓ≠n_{y}≠n_{z}). Biaxial retarders can be fabricated, for example, by biaxially orienting plastic films. As the in-plane retardation of a biaxial retarder approaches zero, the biaxial retarder element behaves more like a c-plate. Generally, a biaxial retarder, as defined herein, has an in-plane retardation of at least 3 nm for 550 nm light. Retarders with lower in-plane retardation are considered c-plates. In many embodiments, a biaxial retarder, has an in-plane retardation of at least 10 nm for 550 nm light and the out-of plane retardation is greater than the product of the in-plane retardation and 0.6.

Those of ordinary skill in the art will readily appreciate that when light is incident at an angle with respect to a surface normal of a medium characterized by both in-plane and out-of-plane birefringences, the light encounters components of both the in-plane and the out-of-plane birefringences. Generally, retardance is a function of (i) the thickness of the optical element such as a film, (ii) nₓ, n_{y}, n_{z}, (iii) the angle of incidence of light, and (iv) the angle between the projection of the plane of incidence onto the film and the slow axis of the film. Calculation of the effective refractive indices and direction of refracted rays as functions of the angle of incidence for the case where the projection of the plane of incidence onto the film coincides with the slow axis of the film is considered by Brehat et al., J. Phys. D: Appl. Phys. 26 (1993) 293-301, the contents of which are hereby incorporated by reference herein. The general case, where the projection of the plane of incidence onto the film makes an angle with respect to the slow axis of the film, is considered by Simon M. C., J. Opt. Soc. Am. A 4 (1987) 2201, the contents of which are hereby incorporated by reference herein.

In any case, a person of ordinary skill in the art can determine optimum retardance for any given angle of incidence using commercially available software that allows one to simulate series of experiments to determine the effect of a birefringent film on polarization state of transmitted light. One example of such software is DIMOS brand software available from Autronic-Melchers GmbH.

Those of ordinary skill in the art will readily appreciate that when light is incident at an acute or obtuse angle at a medium characterized by both in-plane and out-of-plane birefringences, the light encounters components of both the in-plane and the out-of-plane retardations.

By locating a retarder layer between a reflective polarizer and an absorbing polarizer, such as an entrance polarizer of a liquid crystal display, the retarder layer can change the polarization state of light at certain oblique angles of incidence. In addition, the polarization state of on-axis incident light may not be appreciably affected. Because the absorbing polarizer has its polarization transmission axis parallel or substantially parallel to the transmission axis of the reflective polarizer, changing the polarization state of light at certain oblique angles of light travel will reduce the transmission of light at those oblique angles through the absorbing polarizer. This can effectively narrow the illumination cone of the display. Illuminating a liquid crystal display with a narrower cone is found to increase an on-axis contrast ratio of the display. In addition, illuminating a liquid crystal display with a narrower cone is found to improve the black state of the liquid crystal display.

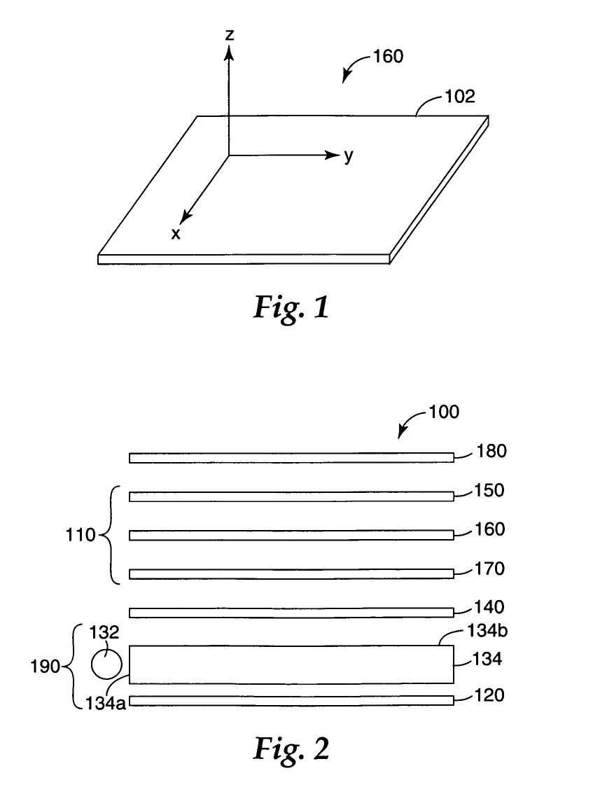

FIG. 1 illustrates a coordinate axis system for use in describing the optical elements. Generally, for display devices, the x and y axes correspond to the width and length of the display and the z axis is typically along the thickness direction of the display. This convention will be used throughout, unless otherwise stated. In the axis system of FIG. 1, the x axis and y axis are defined to be parallel to a major surface 102 of the optical element such as, for example, a retarder 160 and may correspond to width and length directions of a square or rectangular surface. The z axis is perpendicular to that major surface and is typically along the thickness direction of the optical element.

FIG. 2 is a schematic cross-sectional view of an exemplary display device 100 and an exemplary optical film stack 110 constructed according to the present disclosure, a display panel 180 and, optionally, one or more additional optical films and/or components (not shown) as desired for a particular application. Suitable display panels include liquid crystal display panels (LCD panels), such as twisted nematic (TN), single domain vertically aligned (VA), optically compensated birefringent (OCB) liquid crystal display panels and others. The display panel and the lighting device 190 are arranged such that the display panel 180 is disposed between the lighting device 190 and a viewer (not shown), such that the lighting device 190 supplies light to the display panel 180. In this exemplary embodiment, the lighting device 190 can be referred to as a backlight. The optical film stack 110 is disposed between the lighting device 190 and the display panel 180. The optical stack 110 receives light from the light device 190 and transmits light to the display panel 180.

The exemplary optical stack 110 includes a linear absorbing polarizer layer 150 having a first polarizing transmission axis and disposed facing the display panel 180, a linear reflecting polarizer layer 170 having a second polarizing transmission axis substantially parallel to the first polarizing transmission axis and disposed facing the lighting device 190, a retarder layer 160 has an in-plane retardance value of 3 nanometers or less or has an average slow axis forming an angle within ±five degrees or from 85 to 95 degrees to the first or second polarizing transmission axis. The retarder layer 160 is disposed between the linear absorbing polarizer layer 150 and the linear reflecting polarizer layer. In some embodiments, the retarder layer 160 has an average slow axis substantially parallel to the first or second polarizing transmission axis. In other embodiments, the retarder layer 160 has an average slow axis substantially orthogonal to the first or second polarizing transmission axis. In some embodiments, the retarder layer 160 includes two or more retarder layers, or three or more retarder layers, as desired. A retarder layer 160 with an in-plane retardance value of 3 nanometer or less (i.e., three to zero nanometers), can be termed a “c-plate.” In some embodiments, the retarder layer 160 has an out-of-plane retardence value of 100 nm or greater or 200 nm or greater.

The exemplary optical stack includes a linear reflective polarizer 170. The linear reflective polarizer 170 has a light input surface and a light output surface, and it is disposed such that the light output surface faces the retarder 160. The linear reflective polarizer 170 is disposed between the retarder 160 and the lighting device 190. The linear reflective polarizer 170 transmits at least a substantial amount of light having a first polarization characteristic and reflects at least a substantial amount of light having a second polarization characteristic, different from the first polarization characteristic. In many embodiments, the linear reflective polarizer 170 transmits at least 50%, or at least 70%, or at least 90%, of light at normal incidence having the first polarization characteristic and transmits less than 50%, or less than 30%, or less than 10% of light at normal incidence having the second polarization characteristic.

The exemplary optical stack includes a linear absorbing polarizer 150. In some embodiments, the linear absorbing polarizer 150 is an entrance polarizer and is part of the display panel 180. The linear absorbing polarizer 150 has a light input surface and a light output surface, and it is disposed such that the light output surface faces the display panel 180. The linear absorbing polarizer 150 is disposed between the retarder 160 and the display panel 180. The linear absorbing polarizer 150 transmits at least a substantial amount of light having a first polarization characteristic and absorbs at least a substantial amount of light having a second polarization characteristic, different from the first polarization characteristic. In many embodiments, the linear absorbing polarizer 150 transmits at least 50%, or at least 70%, or at least 90%, of light at normal incidence having the first polarization characteristic and transmits less than 50%, or less than 30%, or less than 10% of light at normal incidence having the second polarization characteristic.

In some embodiments, the (one or more) retarder layer 160 is laminated onto the linear reflective polarizer 170. In some embodiments, the retarder layer 160 is laminated onto the linear absorbing polarizer 150. In some embodiments, an air gap exists between the retarder layer 160 and the linear reflective polarizer 170. In some embodiments, an air gap exists between the retarder layer 160 and the linear absorbing polarizer 150. In further embodiments, the retarder layer 160 is laminated between both the linear absorbing polarizer 150 and the linear reflective polarizer 170.

Referring further to FIG. 2, the lighting device 190 may further include a back reflector 120 disposed on the side of the lighting device 190 that faces away from the display panel 180 and the optical stack 110. Suitable back reflectors include specular reflectors, such as mirrors. Suitable mirrors include, without limitation, metal-coated mirrors, such as silver-coated or aluminum-coated mirrors or mirror films, polymeric mirror films, such as multilayer polymeric reflective films. Other suitable back reflectors include diffuse reflectors and reflectors having both specular and diffuse reflectivity components. Diffuse reflectors include, but are not limited to particle-loaded plastic films, particle-loaded voided films and back-scattering reflectors. Reflectors having both specular and diffuse reflectivity components include, without limitation, specular reflectors coated with diffuse coatings, reflectors having a structured surface, reflectors with beaded coatings or while coatings.

The lighting device 190 also includes a light source 132 optically coupled to (i.e., is used to illuminate) the optical stack 110. Any suitable light source or sources are within the scope of the present disclosure, for example, the light source 132 can be a broadband light source or a light source assembly or assemblies. Light sources suitable for use with the present disclosure include one or more CCFLs, LEDs or light source assemblies including LEDs. The light source 132 is preferably optically coupled to (i.e., is caused to enter) a light-distributing element 134, which in some exemplary embodiments can be a substantially planar or wedge-shaped solid or hollow lightguide. In such exemplary embodiments, light from the light source 132 is coupled (i.e., caused to enter) into an edge 134a of the light-distributing element 134 and, after propagating within the light-distributing element 134, e.g., via TIR), it is coupled (i.e., caused to exit) out through the output side 134b in the direction of the optical stack 110. Although the exemplary embodiment shown in FIG. 2 illustrates one light source used in the display device 100 and lighting device 190, other exemplary embodiments can include two or more light sources or arrays of light sources. If more than one light source is used, one or more light sources may be disposed at different edges of the light-distributing element 134.

The lighting device 190 may also include one or more optical elements 140 disposed between the optical stack 110 and the back reflector 120. Exemplary additional optical films include, without limitation, structured surface films and one or more diffusers. In the exemplary lighting device 190, the additional optical elements can include two structured surface films, both having linear prismatic surface structures disposed on the surfaces of the films that face the optical stack 110. Other additional optical films may be used instead of or in addition to the optical films described above, depending on the application.

During operation of the exemplary display devices shown in FIG. 2, light coupled out of the output side 134b of the light-distributing element 134 and transmitted through any optional optical elements 140 and is incident onto the input surface of the reflective polarizer 170 of the optical stack 110. The reflective polarizer 170 receives such light from the light source and transmits at least a substantial portion of light having the first polarization state through its output surface toward the retarder 160 and reflects at least a substantial portion of light having the second polarization state toward the back reflector 120. The transmitted light passes through the retarder 160, where normal or on-axis light is not appreciably altered and oblique light is appreciably altered such that the oblique light transmitted to the absorbing polarizer 150 is then absorbed by the absorbing polarizer 150. For example, in some embodiments, a retardance of at least 50 nm should occur for oblique light traversing the retarder 160 with a 45 degree angle of inclination with respect to the z direction (normal to the plane of the film) and an azimuthal angle of 45 degrees relative to the transmission or pass axis of the absorbing polarizer.

A variety of materials and methods can be used to make a retarder element 160. In some embodiments, the retarder includes a layer of simultaneous biaxially stretched polymeric film being substantially non-absorbing and non-scattering for at least one polarization state of visible light; and having x, y, and z orthogonal indices of refraction wherein at least two of the orthogonal indices of refraction are not equal, an in-plane retardance being in a range from 100 nm or greater and an out-of-plane retardance being 100 nm or greater, or an in-plane retardance from 200 nm or greater and an out-of-plane retardance being 200 nm or greater. In some embodiments, the retarder 160 has an in-plane retardance being in a range from three nanometers or less and an out-of-plane retardance being 100 nm or greater, or an in-plane retardance from three nanometers or less and an out-of-plane retardance being 200 nm or greater. In other embodiments, the retarder 160 has an in-plane retardance being in a range from 50 nm to 100 nm and an out-of-plane retardance being 100 nm or greater, or an in-plane retardance from 50 nm to 200 nm and an out-of-plane retardance being 200 nm or greater.

Any polymeric material capable of being stretched and possessing the optical properties described herein are contemplated. A partial listing of these polymers include, for example, polyolefin, polyacrylates, polyesters, polycarbonates, fluoropolymers and the like. One or more polymers can be combined to form the retarder. Polyolefin includes for example: cyclic olefin polymers such as, for example, polystyrene, norbornene and the like; non-cyclic olefin polymers such as, for example, polypropylene; polyethylene; polybutylene; polypentylene; and the like. A specific polybutylene is poly(1-butene). A specific polypentylene is poly(4-methyl-1-pentene). Polyacrylate includes, for example, acrylates, methacrylates and the like. Examples of specific polyacrylates include poly(methyl methacrylate), and poly(butyl methacrylate). Fluoropolymer specifically includes, but is not limited to, poly(vinylidene fluoride).

The in-plane retardance and out-of-plane retardence of the retarder can be any useful value that alters non-normal or obliquely incident light on the retarder such that at least a portion of the non-normal or obliquely incident light is retarded and converted to a polarization that is then absorbed by the linear absorbing polarizer. In some embodiments, the retarder is a c-plate having an in-plane retardance in a range from zero to three nanometers. In other embodiments, the retarder is a biaxial retarder having an in-plane retardence of 10 nm or greater and an out-of-place retardence value of (0.6 times the in-plane retardence). In other embodiments, the biaxial retarder has an in-place retardence of more than three nanometers, 50 nm or more, 100 nm or more, 200 nm or more, or 300 nm or more, or 50 nm to 1000 nm, 100 nm to 1000 nm, 200 nm to 1000 nm, or 300 nm to 1000 nm. The out-of-plane retardance of the retarder or biaxial retarder can be any useful value that alters non-normal or obliquely incident light on the retarder such that at least a portion of the non-normal or obliquely incident light is retarded and converted to a polarization that is then absorbed by the linear absorbing polarizer such as, for example, 50 nm or more, 100 nm or more, 200 nm or more, or 300 nm or more, or 50 nm to 1000 nm, 100 nm to 1000 nm, 200 nm to 1000 nm, or 300 nm to 1000 nm.

The retarder can have any useful thickness (z direction) such as, for example, 5 micrometers or greater, or 5 micrometers to 200 micrometers, or 5 micrometers to 100 micrometers, or 7 micrometers to 75 micrometers, or 10 micrometers to 50 micrometers.

Crystallization modifiers can be added to the retarder and include, for example, clarifying agents and nucleating agents. Crystallization modifiers can aid in reducing “haze” in the stretched polymeric optical film. Crystallization modifiers can be present in any amount effective to reduce “haze”, such as, for example, 10 ppm to 500000 ppm or 100 ppm to 400000 pm or 100 ppm to 350000 ppm or 250 ppm to 300000 ppm.

In some exemplary embodiments, two or more birefringent retarder elements 160 may be present in the optical stack 110. In some such exemplary embodiments, the two or more birefringent retarder elements 160 may have slow axes disposed at an angle with respect to each other, such that the combined retarder films 160 have an average slow axis arranged as described above. For example, the retarder 160 may include a first birefringent optical element having a first slow axis and a second birefringent optical element having a second slow axis, the first slow axis disposed at an angle with respect to the second slow axis. In other embodiments, the retarder 160 includes one, two, three, or more c-plate retarders.

In many embodiments, the retarder 160 is a birefringent film or combinations of films that provide a balanced level of retardatation across a range of wavelengths of light. A “balanced level of retardation” means that if there is a ⅓ of a wave of retardation for red light at 650 nm, then there will also be approximately ⅓ of a wave of retardation for blue light at 550 nm and for green light at 450 nm. Keeping a balanced level of retardation can reduce color shift from the retarder 160. One method of providing balanced retardation includes selecting a material or blend of materials whose birefringence dispersion is such that the difference between the z-index of refraction of the material and the in-plane indices of refraction increases with increasing wavelength. Another method includes using a combination of two or more optical retardation layers that have different dispersion properties and combining them such that the net effect of the materials gives a balanced level of retardation.

In one illustrative embodiment, a display device similar to the display device 100 shown in FIG. 2. Contrast ratio is determined with and without a retarder 160. The reflective polarizer 170 was Vikuiti™ Dual Brightness Enhancement Film (DBEF), available from 3M Company, St. Paul, Minn., the absorbing polarizer 150 was the entrance polarizer of the display panel 180, and the retarder was a simultaneously biaxially stretched polypropylene film layer that is non-absorbing and non-scattering for at least one polarization state of visible light, with an in-plane retardance absolute value of 50 nm and an out-of plane retardance absolute value of 200 nm. Some suitable retarder films are described in U.S. Patent Application Publication Nos. 2004/0156106 and 2004/0184150, the disclosures of which are hereby incorporated by reference herein. Retardance of the polarization state of light from such a retarder film with incidence angle of 45 degrees and azimuthal incidence angle corresponding to a projection onto the entrance polarizer plane 45 degrees from the entrance polarizer's pass axis is about 100 nm.

Experimental measurements of contrast ratio improvement of a 17″ TN display using one, two and three layers of the above retardation films indicated a +6%, +11.5% and +13% improvement in contrast ratio respectively versus the contrast ratio of the 17″ TN display without the retardation films arranged as described herein.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the instant specification.

We claim:

1. An optical film stack comprising:
a linear absorbing polarizer layer having a first polarizing transmission axis;
a linear reflecting polarizer layer having a second polarizing transmission axis substantially parallel to the first polarizing transmission axis; and
a retarder layer having an out-of-plane retardance value of 80 nanometers or more, or having an in-plane retardance value of 10 nanometers or greater and an out-of-plane retardance value greater than (0.6 times the in-plane retardance value), the retarder layer being disposed between the linear absorbing polarizer layer and the linear reflecting polarizer layer.

2. The optical film stack according to claim 1 wherein the retarder layer has an average slow axis forming an angle within ±five degrees or from 85 to 95 degrees to the first or second polarizing transmission axis.

3. The optical film stack according to claim 1 wherein the retarder layer has an out-of-plane retardance being 100 nm or greater.

4. The optical film stack according to claim 1 wherein the retarder layer has an out-of-plane retardance being 200 nm or greater.

5. The optical film stack according to claim 1 wherein the retarder layer includes two or more retarder layers.

6. The optical film stack according to claim 1 wherein the retarder layer has an average slow axis substantially parallel to the first or second polarizing transmission axis.

7. The optical film stack according to claim 1 wherein the retarder layer has an average slow axis substantially orthogonal to the first or second polarizing transmission axis.

8. The optical film stack according to claim 1 wherein the retarder layer comprises a cyclic polyolefin or a non-cyclic polyolefin.

9. The optical film stack according to claim 1 wherein the retarder layer comprises a polycarbonate or polypropylene.

10. A liquid crystal display comprising:
a liquid crystal layer;
a light source; and
an optical film stack disposed between the first liquid crystal layer and the light source; wherein the optical film stack comprises:
a linear absorbing polarizer layer having a first polarizing transmission axis and disposed facing the liquid crystal layer;
a linear reflecting polarizer layer having a second polarizing transmission axis substantially parallel to the first polarizing transmission axis and disposed to receive light from the light source; and
a retarder layer having an out-of-plane retardance value of 80 nanometers or more, or having an in-plane retardance value of 10 nanometers or greater and an out-of-plane retardance value greater than (0.6 times the in-plane retardance value), the retarder layer being disposed between the linear absorbing polarizer layer and the linear reflecting polarizer layer.

11. The liquid crystal display according to claim 10 wherein the retarder layer has an average slow axis forming an angle within ±five degrees or from 85 to 95 degrees to the first or second polarizing transmission axis.

12. The liquid crystal display according to claim 10 wherein the retarder layer has an out-of-plane retardance being 100 nm or greater.

13. The liquid crystal display according to claim 10 wherein the retarder layer an out-of-plane retardance being 200 nm or greater.

14. The liquid crystal display according to claim 10 wherein the retarder layer includes two or more retarder layers.

15. The liquid crystal display according to claim 10 wherein the retarder layer has an average slow axis substantially parallel to the first or second polarizing transmission axis.

16. The liquid crystal display according to claim 10 wherein the retarder layer has an average slow axis substantially orthogonal to the first or second polarizing transmission axis.

17. The liquid crystal display according to claim 10 wherein the retarder layer comprises a cyclic polyolefin or a non-cyclic polyolefin.

18. A method of increasing an on-axis contrast ratio of a liquid crystal display comprising: providing a liquid crystal display comprising:
a liquid crystal layer;
a light source; and
an optical stack disposed between the liquid crystal layer and the light source;
wherein the optical stack comprises:
a linear absorbing polarizer layer having a first polarizing transmission axis and disposed facing the liquid crystal layer; and
a linear reflecting polarizer layer having a second polarizing transmission axis substantially parallel to the first polarizing transmission axis and disposed to receive light from the light source;
the liquid crystal display having a first on-axis contrast ratio; and
disposing a retarder layer between the linear absorbing polarizer layer and the linear reflecting polarizer layer, the retarder layer having an out-of-plane retardance value of 80 nanometers or more, or having an in-plane retardance value of 10 nanometers or greater and an out-of-plane retardance value greater than (0.6 times the in-plane retardance value), forming an improved liquid crystal display having a second on-axis contrast ratio that is greater than the first on axis contrast ratio.

19. The method according to claim 18 wherein the disposing step comprises disposing a retarder layer between the linear absorbing polarizer layer and the linear reflecting polarizer layer, forming an improved liquid crystal display having a second on-axis contrast ratio that is at least 5% greater than the first on axis contrast ratio.

20. The method according to claim 18 wherein the disposing step comprises disposing a retarder layer between the linear absorbing polarizer layer and the linear reflecting polarizer layer, forming an improved liquid crystal display having a second on-axis contrast ratio that is at least 10% greater than the first on axis contrast ratio.
